(19) United States
(12) Patent Application Publication
(10) Pub. No.: US 2015/0149259 A1
(43) Pub. Date: May 28, 2015

(54) ENTERPRISE PERFORMANCE MANAGEMENT PLANNING MODEL FOR AN ENTERPRISE DATABASE

(71) Applicants: Chang Bin Song, Seoul (KR); Thomas Brodkorb, Wiesloch (DE); Dan Bi Park, Seoul (KR); Jan Rittinger, Walldorf (DE); Jungsoo Seo, Seoul (KR)

(72) Inventors: Chang Bin Song, Seoul (KR); Thomas Brodkorb, Wiesloch (DE); Dan Bi Park, Seoul (KR); Jan Rittinger, Walldorf (DE); Jungsoo Seo, Seoul (KR)

(21) Appl. No.: 14/151,411

(22) Filed: Jan. 9, 2014

Related U.S. Application Data
(60) Provisional application No. 61/908,984, filed on Nov. 26, 2013.

(51) Int. Cl. G06Q 10/06; G06F 17/30

(52) U.S. Cl. CPC G06Q 10/06375; G06F 17/30321
USPC 705/7.37

(57) ABSTRACT

According to some embodiments, actual business data in an enterprise database may be used in accordance with an enterprise performance management planning model, stored and executed by a processor at the enterprise database, to automatically generate predicted business data. The predicted business data may then be stored in an instantiation of a plan data container at the enterprise database.

### CROSS-REFERENCE TO RELATED APPLICATION

The present application claims the benefit of U.S. Provisional Patent Application No. 61/908,984 entitled “ENTERPRISE PERFORMANCE MANAGEMENT PLANNING MODEL FOR AN ENTERPRISE DATABASE” and filed Nov. 26, 2013. The entire contents of that application are incorporated herein by reference.

### FIELD

Some embodiments relate to database systems. In particular, some embodiments concern an enterprise performance management planning model for an enterprise database.

### BACKGROUND

A business or enterprise may be interested in planning for future operations. For example, an enterprise might want to decide if new employees should be added to the business or if another manufacturing plant should be built. To facilitate this type of business planning, predicted values of future business data elements may be generated. For example, a business might predict future sales values (e.g., on a region-by-region basis as well as an overall sales value), profits, etc. Note that predicted future business values may be based on prior actual business values. For example, a business might predict or project that revenues next year will increase 5% as compared to this year's actual revenue.

Typically, an enterprise database storing actual business data may be used by a planning application executing at an application server to generate business predictions. The planning application may request actually business data then use those values to generate predicted data at the application server. The predicted data may then be included in reports, displays, etc. to facilitate business planning. Such an approach, however, may have performance implications. For example, substantial amounts of data may be transferred from the database to the application server and/or mass operations may need to be performed at the application server. Thus, it may be desirable to facilitate implementation of business planning in connection with an enterprise database in an efficient and accurate manner.

### BRIEF DESCRIPTION OF THE DRAWINGS

FIG. 1 is a diagram illustrating the use of an application server to generate business predictions.

FIG. 2 is a block diagram of a system according to some embodiments of the present invention.

FIG. 3 is a flow diagram of a method in accordance with some embodiments described herein.

FIG. 4 is a flow diagram of a method in accordance with some embodiments described herein.

FIG. 5 is an example according to some embodiments.

FIG. 6 is a block diagram of an apparatus in accordance with some embodiments.

FIG. 7 is portion of a tabular representation of database information according to some embodiments.

FIG. 8 illustrates a representation of an EPM planning model in accordance with some embodiments.

FIG. 9 represents a query source model according to some embodiments.

### DETAILED DESCRIPTION

A business or enterprise may be interested in planning for future operations. For example, an enterprise might want to decide if new employees should be added to the business or if another manufacturing plant should be built. To facilitate this type of business planning, predicted or other values of future business data elements may be generated. For example, a business might predict future sales values (e.g., on a region-by-region basis as well as an overall sales value), profits, etc. Note that predicted future business values may be based on prior actual business values. For example, a business might predict or project that revenues next year will increase 5% as compared to this year's actual revenue.

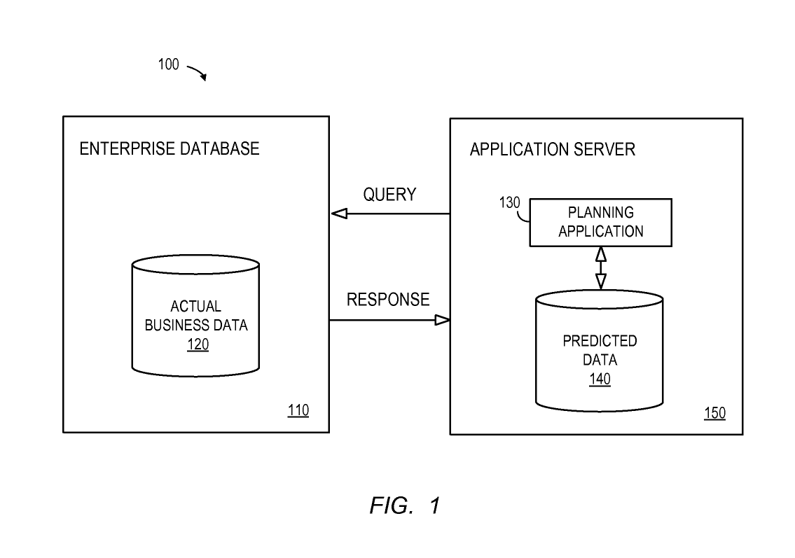

FIG. 1 is a diagram 100 illustrating how an enterprise database 110 storing actual business data 120 may be used by a planning application executing at an application server 150 to generate business predictions. Typically, the planning application 130 may cause a query to be transmitted from the application server to the enterprise database 110. The query might request, for example, how much taxes were paid in a particular country in each of the last five years. The enterprise database 110 may retrieve the information transmit a response with those values to the application server 150. The planning application 130 may then use those values to generate predicted data 140 at the application server 150. The predicted data 140 may then be included in reports, displays, etc. to facilitate business planning.

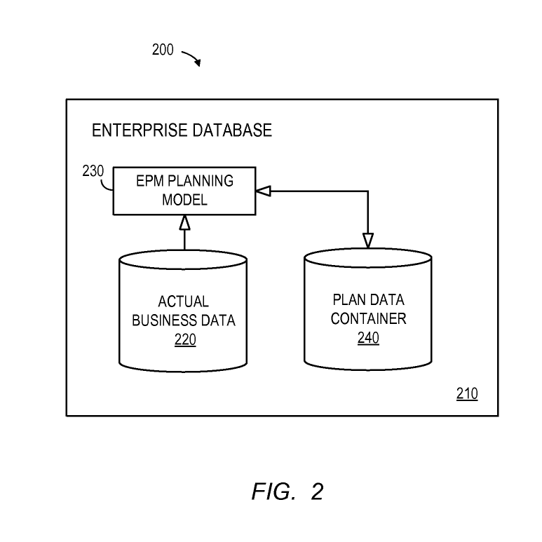

Such an approach, however, may have performance implications. For example, substantial amounts of data may be transferred from the enterprise database 110 to the application server 150 and/or mass operations may need to be performed at the application server 150. According to some embodiments described herein, when only a fraction of the data needs to be displayed (e.g., at an aggregated level), mass operations might be performed at the enterprise database 110, where the substantial amount of data resides, and/or calculations may be performed for the requested aggregates at the enterprise database 110 itself. Moreover, only the data requested to be displayed might be transmitted to the application server 150 or even directly to a User Interface (“UI”). For example, FIG. 2 is a block diagram of a system 200 according to some embodiments of the present invention. The system includes an enterprise database 210 storing actual business data 220. The enterprise database 210 may be associated with a database server process, cache, and/or datastore.

The enterprise database 210 may communicate with one or more database applications (not shown in FIG. 2) over one or more interfaces (e.g., a Structured Query Language (“SQL”)-based interface). The database applications may provide, for example, business reporting, inventory control, online shopping, and/or any other suitable functions. The database applications may, in turn, might support client applications that may be executed by client devices. Such a client application may simply comprise a Web browser to access and display reports generated by a database application.

The data of the enterprise database 210 may be received from disparate hardware and software systems, some of which are not inter-operational with one another. The systems may comprise, for example, a back-end data environment employed in a business or industrial context. The data may be pushed to the enterprise database 210 and/or provided in response to queries received therefrom.

Although embodiments are described with respect to the enterprise database 210, embodiments may also be implemented within one or more nodes of a distributed database, each of which comprises an executing process, a cache and/or a datastore. The data stored in the datastores of each node, taken together, may represent the full database, and the database server processes of each node operate to transparently provide the data of the full database to the aforementioned database applications. The enterprise database 210 may also or alternatively support multi-tenancy by providing multiple logical database systems which are programmatically isolated from one another.

The enterprise database 210 and each element thereof may also include other unshown elements that may be used during operation thereof, such as any suitable program code, scripts, or other functional data that is executable to interface with other elements, other applications, other data files, operating system files, and device drivers. These elements are known to those in the art, and are therefore not described in detail herein. Note that any of the embodiments described herein might be implemented with an in-memory enterprise database or any other type of database.

A database server process may receive requests for data (e.g., SQL requests from a database application), may retrieve the requested data from the actual business data 220 or from a cache, and may return the requested data to the requestor. In some embodiments, a database server process may include an SQL manager to process received SQL statements and a data access manager to manage access to stored data.

The enterprise database 210 may comprise and/or may be implemented by computer-executable program code. For example, the enterprise database 210 may comprise one or more hardware devices, including at least one processor to execute program code so as to cause the one or more hardware devices to provide a database server process. The enterprise database 210 may also include configuration files defining properties of the system (e.g., a size and physical location of each data volume, a maximum number of data volumes in a datastore, etc.). Moreover, the enterprise database 210 may typically includes system files, database parameters, paths, user information and any other suitable information, including metadata describing the database objects that are stored therein. The actual business data 220 may comprise one or more data volumes in some embodiments, with each of the one or more data volumes comprising one or more disparate physical systems for storing data. These physical systems may comprise a portion of a physical hard disk, an entire physical hard disk, a storage system composed of several physical hard disks, and/or Random Access Memory (RAM).

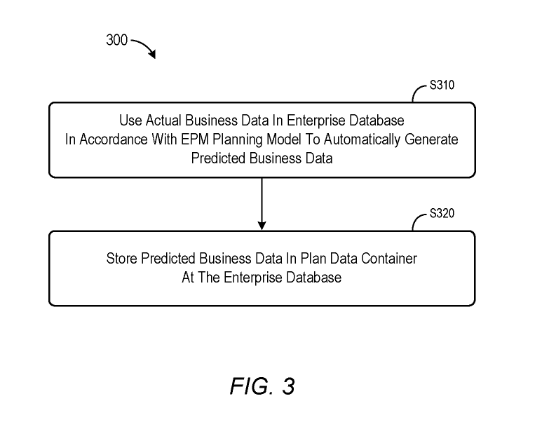

According to some embodiments, the enterprise database 210 includes an Enterprise Performance Management (“EPM”) planning model 230 that describes how to access the actual business data 220. Note that the EPM planning model 230 may be executed at runtime where data can be accessed and manipulated. The EPM planning model 230 may be, for example, similar to programming code that instructs the runtime (at which time the runtime is executing on these instructions). The EPM planning model 230 may use the actual business data 220 to generate predicted values that may be stored at an instantiation of a plan data container 240 at the enterprise database 210. In particular, FIG. 3 is a flow diagram of a method 300 in accordance with some embodiments described herein. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, actual business data in an enterprise database may be used in accordance with an EPM planning model, stored and executed by a processor at an enterprise database, to automatically generate predicted business data. The EPM planning model might, for example, comprise a business simulation.

At S320, the predicted business data may be stored, by the processor, in an instantiation of a plan data container at the enterprise database. According to some embodiments, a plurality of users may share the actual business data in the enterprise database. In this case, each user may be associated with a different instantiations of the plan data container. Moreover, according to some embodiments, a single user may be associated with a plurality of instantiations of the plan data container. For example, a single user might store a pessimistic prediction in a first instantiation of the plan data container and an optimistic prediction in a second instantiation of the plan data container. Note that, as used herein, the phrase “plan data container” may refer to any abstraction of a container that operates as described herein. It may be instantiated for each user, and a single user might decide to create multiple instantiations to capture different simulations and/or predictions.

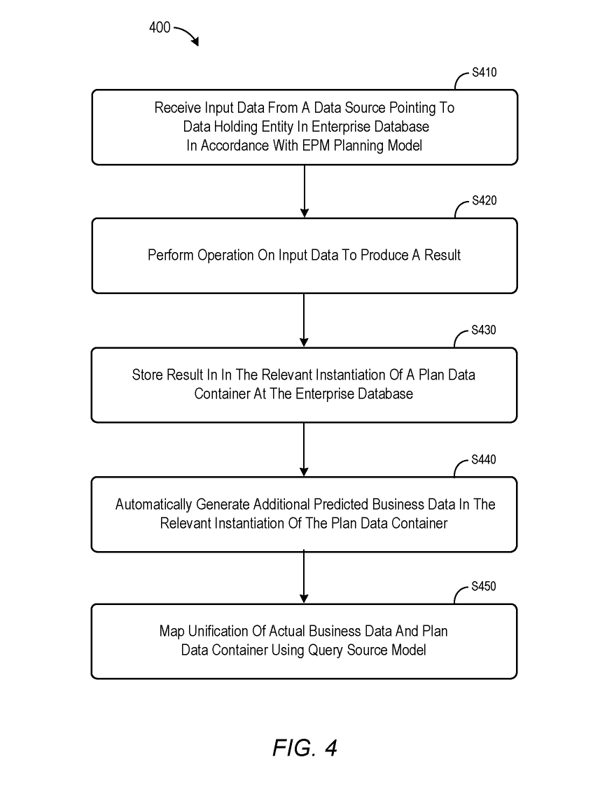

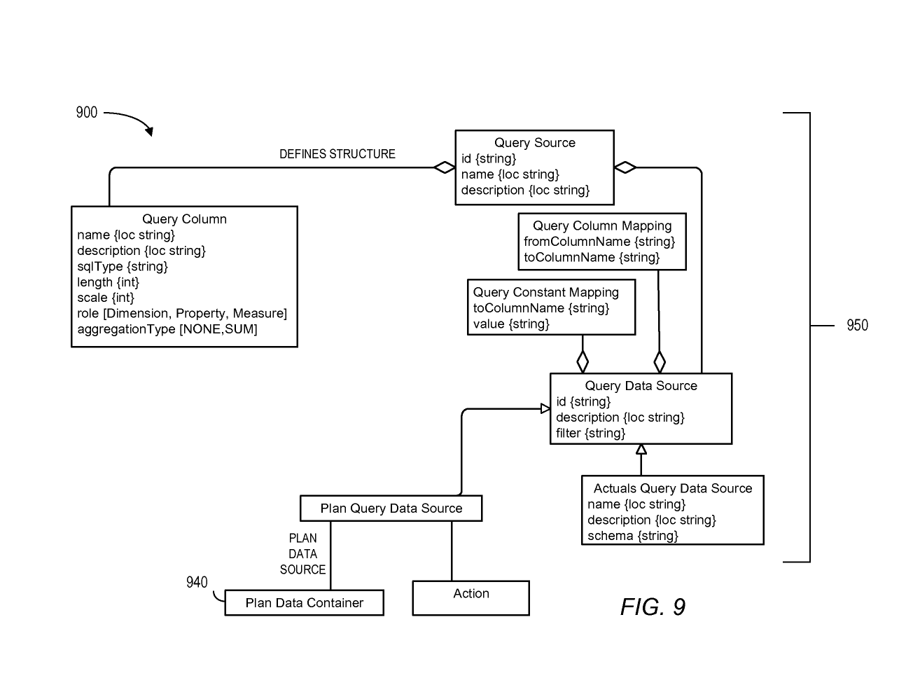

For example, FIG. 4 is a flow diagram of a method 400 in accordance with some embodiments described herein. At S410, input data may be received from a data source pointing to a data holding entity in an enterprise database in accordance with an EPM planning model. An operation may then be performed on the input data at S420 to produce a result. At S430, the result may be stored in a data target pointing to a data holding entity in an instantiations of a plan data container at the enterprise database. Additional predicted business data in the relevant instantiations of the plan data container may also be automatically generated at S440. According to some embodiments, changed data in a plan data container are performed by operations (such as in S420) which are orchestrated in algorithms which are orchestrated in actions. As described with respect to FIG. 9, a query source model may map the unification of the actual business data and plan data container at 5450. The runtime provides a user-specific resolution (instantiation) of the plan data container to provide for the unification of actual data with data from the instantiation of the plan data container.

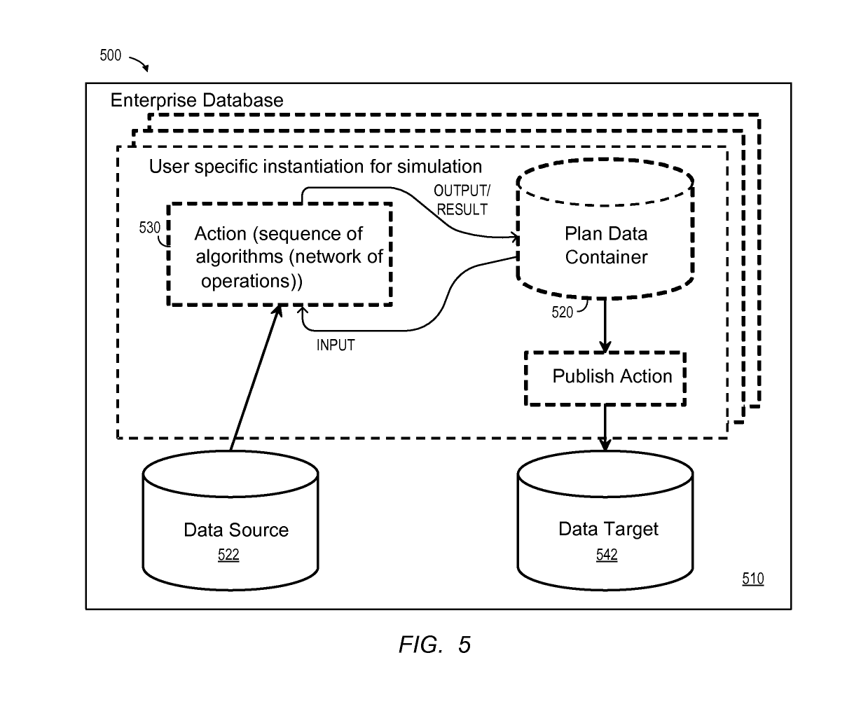

Consider, for example, FIG. 5 which illustrates an example 500 where an enterprise database 510 having multiple, user-specific instantiations for simulation and a data source 522 (e.g., actual sales figures). An action 530 (e.g., a sequence of algorithms which may be a network of operations) may receive a value from the data source 522 as a data input and generate a result. The result may be, for example, a predicted business value that is stored into a data target 542 (e.g., predicted sales figures) via an instantiation of a plan data container 540 and a publish action. According to some embodiments, projection and filters may be captured in the parameterization of operations. Note that not every action might alter the data target 542. According to some embodiments, only “publish” operations alter the data target 542 while other operations may store a result in the instantiation of the plan data container 520. This may facilitate the “simulation” process associated with typical patterns of business planning (e.g., a planner might not want to publically persist changes performed while he or she is planning). Thus, instantiations of the plan data container 520 may comprise a fast, in-database store (which may be persisted) that keeps data in a private environment. Only the planner who created the data may be permitted to access the data (unless he or she decides to publish the data).

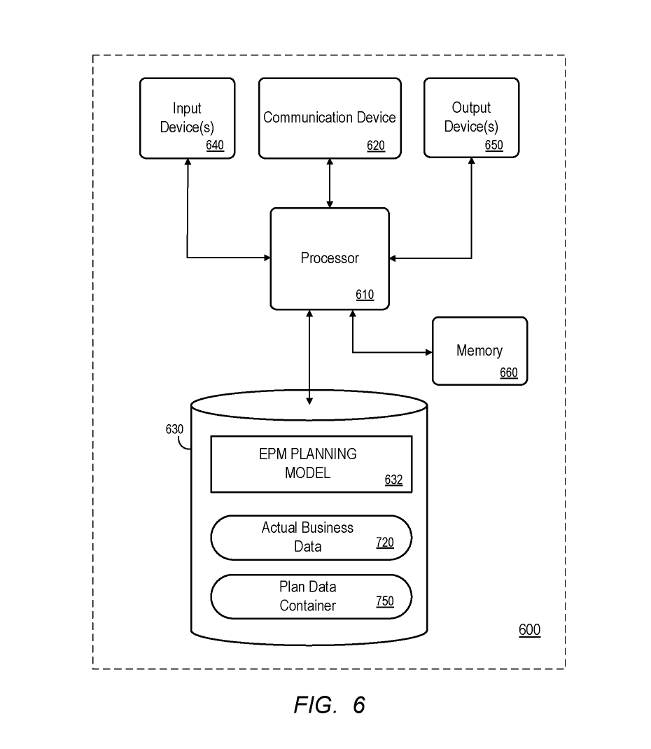

FIG. 6 is a block diagram of an apparatus 600 according to some embodiments. The apparatus 600 may comprise a general-purpose computing apparatus and may execute program code to perform any of the functions described herein. The apparatus 600 may comprise an implementation of the enterprise database 210 of FIG. 2. The apparatus 600 may include other unshown elements according to some embodiments.

The apparatus 600 includes a processor 610 operatively coupled to a communication device 620, a data storage device 630, one or more input devices 640, one or more output devices 650 and a memory 660. The communication device 620 may facilitate communication with external devices, such as a reporting client, or a data storage device. The input device(s) 640 may comprise, for example, a keyboard, a keypad, a computer mouse or other pointing device, a microphone, knob or a switch, an infra-red (IR) port, a docking station, and/or a touch screen. The input device(s) 640 may be used, for example, to enter EPM planning data into apparatus 600. The output device(s) 650 may comprise, for example, a display (e.g., a display screen) a speaker, and/or a printer.

The data storage device 630 may comprise any appropriate persistent storage device, including combinations of magnetic storage devices (e.g., magnetic tape, hard disk drives and flash memory), optical storage devices, Read Only Memory (ROM) devices, etc., while the memory 660 may comprise Random Access Memory (RAM).

Program code associated with the EPM planning model 632 may be executed by a processor 610 to cause the apparatus 600 to perform any one or more of the processes described herein. Embodiments are not limited to execution of these processes by a single apparatus. According to some embodiments, data storage device 630 further includes persisted data such as columnar tables, delta structures and other data associated with a datastore, while the memory 660 may store columnar tables, delta structures and other data described above as being stored in a volatile memory. The data storage device 630 may also store data and other program code for providing additional functionality and/or which are necessary for operation thereof, such as device drivers, operating system files, etc.

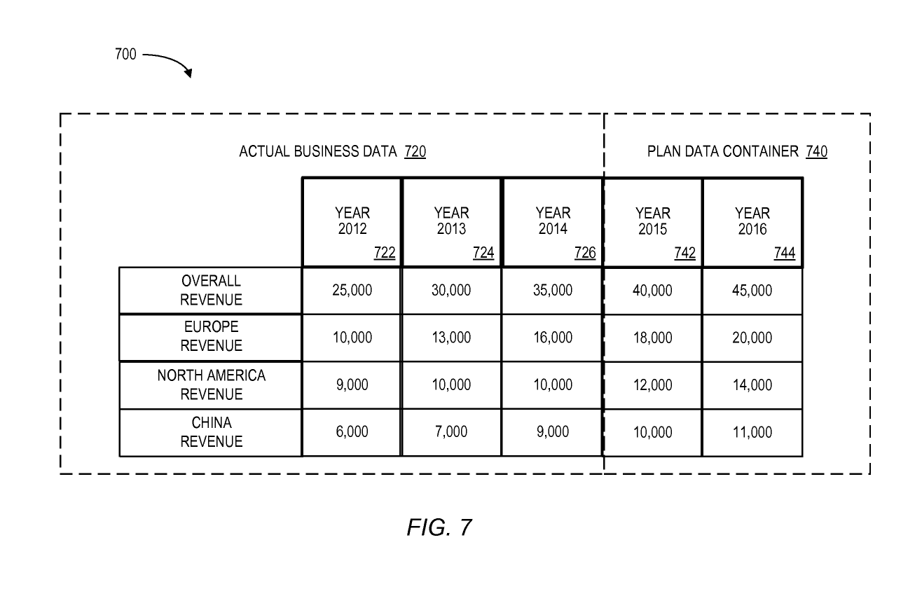

FIG. 7 is portion of a tabular representation of database information 700 according to some embodiments. In particular, both actual business data 720 and plan data container 740 information is displayed. In the example of FIG. 7, business data for overall revenue, Europe revenue, North America revenue, and China revenue includes: actual revenue values 722, 724, 726 and predicted future revenue values 742, 744 in the plan data container 740. Note that all users may share actual business data 720 while different users may each be associated with different plan data containers 740.

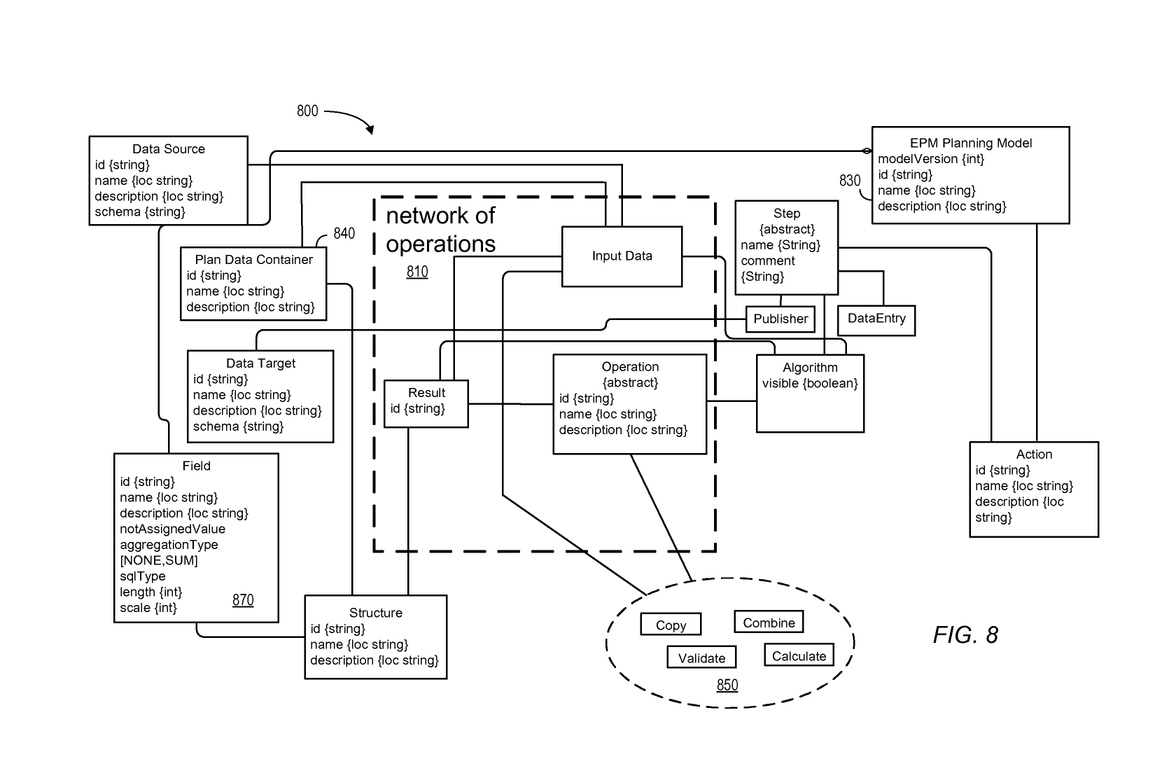

FIG. 8 illustrates a representation of an EPM planning model 800 that includes a network of operations 810 in accordance with some embodiments. Note that an inheritance relation between the superclass InputData and its sub-classes “Result,” “Data Source,” and “Plan Data Container” may enable the network of operations 810. Further, one operation may use a data source as input and produce a result as an output which in turn may be an input to another operation, etc. In particular, the network of operations 810 includes input data, operations, and a result to be stored to a structure. The representation 800 includes an EPM planning model 830 and fields 870. Moreover, a data source may point to existing data holding entities in a database, such as cubes, analytic views, join views, calculation views, column table, etc. and the operations 850 may read data from these data sources. A data target may point to an existing data holding entity in the database (e.g., it may be writable and a “publisher” algorithm may write data from a plan data container 840 to the corresponding data target). Note that for clarity, not all containment relations are illustrated in FIG. 8. In general, all classes shown are contained in a container class that may be referred to as an EPM planning model. The set of classes described with respect to FIG. 8 may be considered an EPM planning “meta” model. Instances of these classes may be referred to as the EPM planning model. Such an EPM planning model may then be executed at runtime. At that point, the runtime may access and manipulate data as described in the EPM planning model. Note that the EPM planning model 830 may play a similar role as the query source model 950 of FIG. 9.

The plan data container 840 might comprise, for example, a simple table used to let different planners have different instances of predicted data. Moreover, the plan data container 840 may define a planning structure by referring to a structure which in turn lists a set of fields 870 which reflect dimensions and measures of business data. The plan data container 840 may be altered by algorithms which provide a result that is applied to the plan data container 840, which can also be used as “input data” for other operations. According to some embodiments, the plan data container 840 supports different kinds of persistency levels, such as “transient”, “saved” and/or “published”.

The operations 850 may operate on a structure, consume input data, and produce results. Note that a result may, according to some embodiments, be used as input data such that a plan designer can stitch together a data flow graph of operations. Examples of operations 850 may include calculate, copy, combine, script, and/or lookup. If no appropriate operation 850 is available to express a desired operation, SQL Script (with planning extensions) might be used to code the operation. This may be considered as a planning specific programming language (“Exit”).

The result of an operation may be expressed as entities of an object. Input data may be associated with an abstract class representing all types of input data for an operation 850. For example, concrete classes of input data may include “plan data container”, “data source” and “result”. According to some embodiments, a parameter may replace any sub-class of data. In this sense, a parameter is so to say a configuration of the respective data object which is deferred from design time to runtime. The type definition may help the infrastructure decide if the model is correct. At runtime all parameter definitions associated with an action may be retrieved and provided with values by the client.

A planning algorithm may interface with the plan data container 840 via a query view. Moreover, the planning algorithm may execute operations 850 (e.g., copy, combine, etc.) such as a single activity that may or may not change the data in the plan data container 840. The planning algorithm may point to one result of one operation 850 that operates on a structure by consuming input data and producing a result. Note that a result may, according to some embodiments, be used as input data such that a plan designer can stitch together a data flow graph of operations 850. According to some embodiments, a single operation 850 is an instance of one specific operation offered by the EPM planning model. During instantiation, the interface of the specific operation 850 may need to be satisfied. This might be done explicitly or by defining a parameter which may stand in for missing values.

As used herein, an “action” may express all data changing activities that can be triggered by a user and/or the EPM planning model 830. Note that such a user interaction may require multiple planning activities, which may be represented by a sequence of algorithms. According to some embodiments, a single algorithm alters the data of one specific plan data container 840 and an action lists multiple algorithms (e.g., an action may act across multiple plan data containers 840).

Note that the field 870 may be associated with characteristics (which in turn may be associated with characteristic relationships and/or a hierarchy via a master data container) and/or key-figures. According to some embodiments, the field 870 comprises a representation of a field (column/element) in the context of planning and a data type and size can be either defined explicitly or by pointing to column in a data source. According to some embodiments multiple fields 870 may be combined into a structure that can be used is used to define a structure of the plan data container 840, a result and/or an “operation.”

FIG. 9 illustrates a system 900 including a plan data container 940 interacting with a query source model 950 according to some embodiments. Note that in typical planning use cases, a user may want to compare plan (predicted) and actual data. As described herein, the plan data container 940 may be the abstract modeling concept that holds the plan data in a user specific version (simulation). As the plan data container 940 is an abstract concept, it cannot directly be queried. An EPM platform may provide a (user specific) resolution from the plan data container to a real existing storage area. The query source model 950 may serve two purposes in this regard (similar to the EPM planning model 830 of FIG. 8): (i) it may resolve the plan data container 940 to a real storage at runtime, and (ii) it may define the how the plan and actual data should be unified A query source may be an abstract data source that can be consumed by a planning UI. It may define how the actual data and plan data will be used and how they should be unified. The unification may be, for example, supported with mappings. As used herein, a “query source” might refer to exactly one EPM planning model (but to multiple plan data containers within this EPM planning model).

Moreover, a query column and query data source may consist of multiple query data sources which might be either plan and/or actual data. Actual data might be modeled by specifying the name of an existing database entity or view. Plan data may be specified by pointing to a plan data container of an existing EPM planning model. It may also point to one (or more) actions defined in the same EPM planning model. Those actions may, for example, be used to enter data. Thus, only those actions may be used in a plan query data Source which provide a data entry algorithm for the plan data container 940 it points to.

Thus, embodiments may provide a model for enterprise performance management related data manipulations (calculations, changes, adoptions, etc.). Embodiments may also be seen as new programming language/model for business planning. The database itself may fully support the lifecycle of instances of the model. Embodiments may allow for compilation (design time representation to runtime representation); runtime user specific model instantiation, calculation, storage of simulation data by the user; built in simulation; and server side management of versions of simulation data.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of systems herein may include a processor to execute program code such that the computing device operates as described.

All systems and processes discussed herein may be embodied in program code stored on one or more computer-readable media. Such media may include, for example, a floppy disk, a CD-ROM, a DVD-ROM, a Flash drive, magnetic tape, and solid state RAM or ROM storage units. Embodiments are therefore not limited to any specific combination of hardware and software.

Elements described herein as communicating with one another are directly or indirectly capable of communicating over different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

What is claimed is:

1. A method associated with an enterprise database, comprising:
using actual business data in the enterprise database in accordance with an enterprise performance management planning model, stored and executed by a processor at the enterprise database, to automatically generate predicted business data; and
storing, by the processor, the predicted business data in an instantiation of a plan data container at the enterprise database.

2. The method of claim 1, wherein the enterprise performance management planning model comprises a business simulation.

3. The method of claim 1, wherein the enterprise performance management planning model includes:
a data source pointing to a data holding entity in the enterprise database, and
a data target pointing to a data holding entity in the instantiation of the plan data container at the enterprise database.

4. The method of claim 3, wherein the enterprise performance management planning model further includes:
input data received from the data source, and
an operation performed on the input data to produce a result stored in the data target.

5. The method of claim 1, further comprising:
providing a user specific instantiation of the plan data container to a storage area of the enterprise database, wherein a query source model maps the unification of the actual business data and the relevant instantiation of the plan data container.

6. The method of claim 1, wherein a plurality of users share the actual business data in the enterprise database and each user is associated with a different instantiations of the plan data container.

7. The method of claim 1, wherein a single user is associated with a plurality of instantiations of the plan data container.

8. A non-transitory computer-readable medium storing program code, the program code executable by a computing system storing an enterprise database structure, the program code when executed by the computing system cause the computing system to:
use actual business data in the enterprise database in accordance with an enterprise performance management planning model, stored at the enterprise database, to automatically generate predicted business data; and
store the predicted business data in an instantiation of a plan data container at the enterprise database.

9. The medium of claim 6, wherein the enterprise performance management planning model comprises a business simulation.

10. The medium of claim 6, wherein the enterprise performance management planning model includes:
a data source pointing to a data holding entity in the enterprise database, and
a data target pointing to a data holding entity in the instantiation of the plan data container at the enterprise database.

11. The medium of claim 8, wherein the enterprise performance management planning model further includes:
input data received from the data source, and
an operation performed on the input data to produce a result stored in the data target.

12. The medium of claim 6, wherein execution of the program code further causes the computer system to:
provide a user specific instantiation of the plan data container to a storage area of the enterprise database, wherein a query source model maps the unification of the actual business data and the relevant instantiation of the plan data container.

13. The method of claim 6, wherein a plurality of users share the actual business data in the enterprise database and each user is associated with a different instantiation of the plan data container.

14. The medium of claim 6, wherein a single user is associated with a plurality of instantiations of plan data container.

15. A system, comprising:
an enterprise database storage element, containing:
actual business data, and
a plan data container;
a platform coupled to the enterprise database storage element, the platform being adapted to: (i) use the actual business data in accordance with an enterprise performance management planning model, stored at the system, to automatically generate predicted business data, and (ii) store the predicted business data in an instantiation of the plan data container.

16. The system of claim 15, wherein the enterprise performance management planning model comprises a business simulation.

17. The system of claim 15, wherein the enterprise performance management planning model includes:
a data source pointing to a data holding entity in the enterprise database, and
a data target pointing to a data holding entity in the instantiation of the plan data container at the enterprise database.

18. The system of claim 17, wherein the enterprise performance management planning model further includes:
input data received from the data source, and
an operation performed on the input data to produce a result stored in the data target.

19. The system of claim 1, the platform being further adapted to: (iii) provide a user specific instantiation of the plan data container to a storage area of the enterprise database, wherein a query source model maps the unification of the actual business data and the instantiation of the plan data container.

20. The system of claim 15, wherein a plurality of users share the actual business data and each user is associated with a different instantiation of the plan data container.

21. The system of claim 15, wherein a single user is associated with a plurality of instantiations of the plan data container.
